(19) United States
(12) Patent Application Publication
(10) Pub. No.: US 2026/0059477 A1
(43) Pub. Date: Feb. 26, 2026

(54) METHOD AND APPARATUS USED FOR POSITIONING

(71) Applicant: Bunker Hill Technologies LLC, Allen, TX (US)

(72) Inventors: Jin LIU, Shanghai (CN); Xiaobo ZHANG, Shanghai (CN)

(21) Appl. No.: 19/103,368

(22) PCT Filed: Aug. 10, 2023
(86) PCT No.: PCT/CN2023/112239

§ 371 Date: Feb. 12, 2025

(30) Foreign Application Priority Data
Aug. 16, 2022 (CN) 202210978886.1

(51) Int. Cl. H04W 64/00; H04L 5/00; H04W 56/00; H04W 72/25

(52) U.S. Cl. CPC H04W 64/00; H04L 5/0048; H04W 56/0065; H04W 72/25

(57) ABSTRACT

Disclosed in the present application are a method and apparatus used for positioning. The method comprises: a first node receiving a first message; executing first measurement in at least a first RS resource to obtain the reception timing of a first time unit; and sending first position information, wherein the first message indicates a first time length, and the reception timing of the first time unit and the first time length are jointly used for generating the first position information. The present application solves the effect of timing adjustment on position information estimation.

### RELATED APPLICATIONS

This application is a National Stage under 35 USC 371 of and claims priority to International Application No. PCT/CN2023/112239, filed Aug. 10, 2023, which claims the priority benefit of CN Application No. 202210978886.1, filed Aug. 16, 2022.

### TECHNICAL FIELD

The present application relates to a transmission method and device in a wireless communication system, and in particular to a positioning-related scheme and device in wireless communication.

### BACKGROUND ART

Positioning is an important application in the field of wireless communications. The emergence of new applications such as V2X (Vehicle to everything) or industrial Internet of Things has put forward higher requirements for positioning accuracy or latency. In the 3GPP (3rd Generation Partner Project) RAN (Radio Access Network) #94e meeting, a research project on positioning enhancement was launched.

### SUMMARY OF THE INVENTION

According to the work plan in RP-213588, NR Rel-18 needs to support enhanced positioning technology for sidelink positioning (SL Positioning), among which the mainstream sidelink positioning technologies include SL RTT technology, SL AOA, SL TDOA and SL AOD, etc., and the execution of these technologies depends on the measurement of SL PRS (Sidelink Positioning Reference Signal). Since the sender of SL PRS may be mobile, the traditional positioning process or location information feedback scheme needs to be further enhanced.

In response to the above problems, the present application discloses a positioning solution. It should be noted that in the description of the present application, only the V2X scenario is used as a typical application scenario or example; the present application is also applicable to scenarios other than V2X facing similar problems, such as public safety (Public Safety), industrial Internet of Things, etc., and achieves technical effects similar to those in the NR V2X scenario. In addition, although the motivation of the present application is for the scenario where the sender of the wireless signal used for positioning measurement is mobile, the present application is still applicable to the scenario where the sender of the wireless signal used for positioning measurement is fixed, such as RSU (Road Side Unit). The use of a unified solution for different scenarios also helps to reduce hardware complexity and cost. In the absence of conflict, the embodiments and features in any node of the present application can be applied to any other node. In the absence of conflict, the embodiments and features in the embodiments of the present application can be combined with each other arbitrarily.

If necessary, reference may be made to 3GPP standards TS38.211, TS38.212, TS38.213, TS38.214, TS38.215, TS38.321, TS38.331, TS38.305, TS37.355 to assist in understanding the present application.

The present application discloses a method in a first node used for wireless communication, characterized by comprising:
receiving a first message;
Performing a first measurement in at least a first RS (Reference Signal) resource to obtain a reception timing of a first time unit;
sending first location information;
The first message indicates a first time length, and the reception timing of the first time unit and the first time length are used together to generate the first location information.

As an embodiment, the problem to be solved by the present application is: a timing adjustment of a UE sending a first RS causes a measurement error of the first location information.

As an embodiment, the method of the present application is: establishing a relationship between the generation of the first position information and the first time length.

As an embodiment, the method of the present application is: establishing a relationship between the generation of the first position information and the first time length and the reception timing of the first time unit.

As an embodiment, the method of the present application helps the sender of the first RS resource to flexibly adjust the sending timing.

As an embodiment, the method of the present application is helpful in saving the signaling overhead of the first location information.

As an embodiment, the method of the present application solves the impact of timing adjustment on position information estimation.

According to one aspect of the present application, the above method is characterized in that the first location information includes a first sending and receiving time difference, and the first sending and receiving time difference is the linear sum of the receiving timing of the first time unit, the first time length and the sending timing of the second time unit.

According to one aspect of the present application, the above method is characterized in that the at least first RS resource includes multiple first-class RS resources, the first RS resource is one of the multiple first-class RS resources, and at least one first-class RS resource among the multiple first-class RS resources is used to carry SL PRS (Sidelink Positioning Reference Signal).

According to one aspect of the present application, the above method is characterized in that the first time unit includes the time domain resources of the first RS resource, or the first time unit includes the time domain resources of one first type RS resource among the multiple first type RS resources.

According to one aspect of the present application, the above method is characterized in that the second time unit is closest to the first time unit in the time domain.

According to one aspect of the present application, the above method is characterized in that the first resource pool includes multiple first-class time units in the time domain, and the first time unit is a first-class time unit of the time domain resources including the first RS resource among the multiple first-class time units included in the time domain of the first resource pool.

According to one aspect of the present application, the above method is characterized in that the first resource pool includes multiple first-class time units in the time domain, the first time unit is a first-class time unit in the first resource pool, and the second time unit is a first-class time unit that is closest to the first time unit in the time domain among the multiple first-class time units included in the first resource pool.

According to one aspect of the present application, the above method is characterized in that the second time unit is used by the first node to send a wireless signal.

According to one aspect of the present application, the above method is characterized in that the first message is an SCI, or the first message is an SL MAC CE.

According to one aspect of the present application, the above method is characterized in that the first resource pool includes the at least first RS resource, the time-frequency resources occupied by the first message belong to the second resource pool, and the second resource pool is different from the first resource pool.

According to one aspect of the present application, the above method is characterized in that the first node is a user equipment (UE, User Equipment).

According to one aspect of the present application, the above method is characterized in that the first node is a relay node.

According to one aspect of the present application, the above method is characterized in that the first node is a road side unit (RSU).

The present application discloses a method used in a second node of wireless communication, characterized by comprising:
Sending a first message;
sending at least a first RS on at least a first RS resource;
receiving first location information;
The first message indicates a first time length, the first location information includes a first sending and receiving time difference, and the first sending and receiving time difference is related to the first time length.

According to one aspect of the present application, the above method is characterized in that the first location information includes a first equivalent receiving and transmitting time difference, and the first equivalent receiving and transmitting time difference is the linear sum of the receiving timing of the first time unit, the first time length and the sending timing of the second time unit.

According to one aspect of the present application, the above method is characterized in that the at least first RS resource includes multiple first-class RS resources, the first RS resource is one of the multiple first-class RS resources, the at least first RS includes multiple first-class RSs, and at least one first-class RS among the multiple first-class RSs is a SL PRS.

According to one aspect of the present application, the above method is characterized in that the first time unit includes the time domain resources of the first RS resource, or the first time unit includes the time domain resources of one first type RS resource among the multiple first type RS resources.

According to one aspect of the present application, the above method is characterized in that the second time unit is closest to the first time unit in the time domain.

According to one aspect of the present application, the above method is characterized in that the first resource pool includes multiple first-class time units in the time domain, and the first time unit is a first-class time unit of the time domain resources including the first RS resource among the multiple first-class time units included in the time domain of the first resource pool.

According to one aspect of the present application, the above method is characterized in that the first resource pool includes multiple first-class time units in the time domain, the first time unit is a first-class time unit in the first resource pool, and the second time unit is a first-class time unit that is closest to the first time unit in the time domain among the multiple first-class time units included in the first resource pool.

According to one aspect of the present application, the above method is characterized in that the second time unit is used by the second node to receive a wireless signal from the first node.

According to one aspect of the present application, the above method is characterized in that the first message is an SCI, or the first message is an SL MAC CE.

According to one aspect of the present application, the above method is characterized in that the first resource pool includes the at least first RS resource, the time-frequency resources occupied by the first message belong to the second resource pool, and the second resource pool is different from the first resource pool.

According to one aspect of the present application, the above method is characterized in that the second node is a user equipment.

According to one aspect of the present application, the above method is characterized in that the second node is a relay node.

According to one aspect of the present application, the above method is characterized in that the second node is a roadside device.

The present application discloses a first node used for wireless communication, characterized in that it includes:

A first receiver receives a first message; performs a first measurement in at least a first RS resource to obtain a reception timing of a first time unit;

A first transmitter sends first position information;

The first message indicates a first time length, and the reception timing of the first time unit and the first time length are used together to generate the first location information.

The present application discloses a second node used for wireless communication, characterized in that it includes:
A second transmitter sends a first message; sends at least a first RS on at least a first RS resource;
A second receiver receives the first location information;
The first message indicates a first time length, the first location information includes a first sending and receiving time difference, and the first sending and receiving time difference is related to the first time length.

### BRIEF DESCRIPTION OF THE DRAWINGS

Other features, objects, and advantages of the present disclosure will become more apparent upon reading the detailed description of non-limiting embodiments with reference to the following drawings:

FIG. 1 shows a processing flow chart of a first node according to an embodiment of the present application;

FIG. 2 shows a schematic diagram of a network architecture according to an embodiment of the present application;

FIG. 3 shows a schematic diagram of a wireless protocol architecture of a user plane and a control plane according to an embodiment of the present application;

FIG. 4 shows a schematic diagram of a first communication device and a second communication device according to an embodiment of the present application;

FIG. 5 shows a structural diagram of UE positioning according to an embodiment of the present application;

FIG. 6 shows a wireless signal transmission flow chart according to an embodiment of the present application;

FIG. 7 is a schematic diagram showing the relationship between the first receiving and sending time difference and the receiving timing of the first time unit, the first time length, and the sending timing of the second time unit according to an embodiment of the present application;

FIG. 8 is a schematic diagram showing a relationship between a first time unit and a second time unit according to an embodiment of the present application;

FIG. 9 shows a structural block diagram of a processing device used in a first node according to an embodiment of the present application;

FIG. 10 shows a structural block diagram of a processing device used in a second node according to an embodiment of the present application.

### DETAILED DESCRIPTION

The technical solution of the present application will be further described in detail below in conjunction with the accompanying drawings. It should be noted that, in the absence of conflict, the embodiments of the present application and the features in the embodiments can be arbitrarily combined with each other.

### EXAMPLE 1

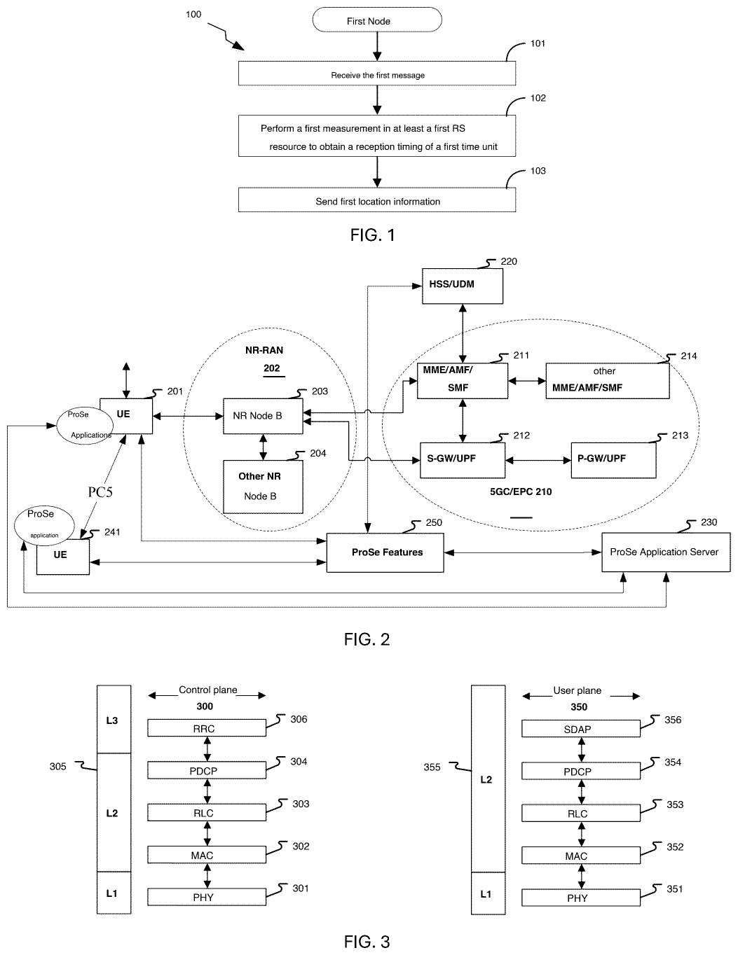

Embodiment 1 illustrates a processing flow chart of a first node of an embodiment of the present application, as shown in FIG. 1. In FIG. 1, each box represents a step.

In Example 1, the first node in the present application executes step 101 to receive a first message; in step 102, a first measurement is performed in at least a first RS (Reference Signal) resource to obtain a receiving timing of a first time unit; finally, step 103 is performed to send first location information; the first message indicates a first time length, and the receiving timing of the first time unit and the first time length are jointly used to generate the first location information (location Information).

As an embodiment, the first RS is used for positioning.

As an embodiment, the first RS is used to obtain a Rx-Tx Time Difference.

As an embodiment, the first RS is used to obtain the reception timing of the first RS.

As an embodiment, the first RS is used to obtain the receiving timing of the first time unit.

As an embodiment, the first RS includes an SL RS (Sidelink Reference Signal, sidelink reference signal).

As an embodiment, the first RS includes an SL PRS (Sidelink Positioning Reference Signal, sidelink positioning reference signal).

As an embodiment, the first RS includes an SRS (Sounding Reference Signal).

As an embodiment, the first RS includes at least one of S-PSS (Sidelink Primary Synchronization Signal), S-SSS (Sidelink Secondary Synchronization Signal), and PSBCH (Physical Sidelink Broadcast Channel).

As an embodiment, at least the first RS only includes the first RS.

As an embodiment, at least the first RS includes a plurality of first-category RSs, and the first RS is one of the plurality of first-category RSs.

As an embodiment, the multiple first-category RSs are all used for positioning.

As an embodiment, the multiple first-type RSs are all used to obtain the time difference between sending and receiving.

As an embodiment, the multiple first-type RSs are all used to obtain receiving timing.

As an embodiment, the multiple first-type RSs are all used to obtain the receiving timing of the first time unit.

As an embodiment, at least one first-category RS among the plurality of first-category RSs is a SL PRS.

As an embodiment, at least one first-category RS among the multiple first-category RSs is an SRS.

As an embodiment, at least one first-category RS among the multiple first-category RSs is an SL PRS, and at least one first-category RS among the multiple first-category RSs is an SRS.

As an embodiment, the at least first RS resource includes a plurality of REs (Resource Elements).

As an embodiment, the at least first RS resource is used to carry the at least first RS.

As an embodiment, the at least first RS resource is reserved for the at least first RS.

As an embodiment, the at least first RS resource is the time-frequency resource occupied by the at least first RS.

As an embodiment, the at least first RS resource only includes the first RS resource.

As an embodiment, the at least first RS resource includes multiple first-category RS resources.

As an embodiment, the first RS resource is used to carry the first RS.

As an embodiment, the first RS resource is reserved for the first RS.

As an embodiment, the first RS resource is the time-frequency resource occupied by the first RS.

As an embodiment, the first RS resource occupies at least one multi-carrier symbol in the time domain, and the first RS resource occupies at least one subcarrier in the frequency domain.

As an embodiment, the time domain resources occupied by the first RS resources belong to a time slot, and the frequency domain resources occupied by the first RS resources span a PRB (Physical Resource Block).

As an embodiment, the time domain resources occupied by the first RS resources belong to a time slot, and the frequency domain resources occupied by the first RS resources belong to a Subchannel.

As an embodiment, the first RS resource includes a full-staggered pattern.

As an embodiment, the first RS resource includes a semi-staggered pattern.

As an embodiment, the first RS resource includes an unstaggered pattern.

As an embodiment, any one of the multiple first-category RS resources occupies at least one multi-carrier symbol in the time domain, and any one of the multiple first-category RS resources occupies at least one subcarrier in the frequency domain.

As an embodiment, the time domain resources occupied by any first-category RS resource among the multiple first-category RS resources belong to a time slot, and the frequency domain resources occupied by any first-category RS resource among the multiple first-category RS resources span a PRB.

As an embodiment, the time domain resources occupied by any first-category RS resource among the multiple first-category RS resources belong to a time slot, and the frequency domain resources occupied by any first-category RS resource among the multiple first-category RS resources belong to a Subchannel.

As an embodiment, the at least first RS resource belongs to the first resource pool.

As an embodiment, the first resource pool includes at least the first RS resource.

As an embodiment, the first RS resource belongs to a first resource pool.

As an embodiment, the first resource pool includes the first RS resources.

As an embodiment, the first resource pool includes multiple time slots in the time domain, and the first resource pool includes at least one sub-channel in the frequency domain.

As an embodiment, the first resource pool includes multiple time slots in the time domain, and the first resource pool includes multiple PRBs in the frequency domain.

As an embodiment, the time domain resources of the first RS resources belong to a time slot in the first resource pool.

As an embodiment, the frequency domain resources of the first RS resources include at least one PRB in the first resource pool.

As an embodiment, the frequency domain resources of the first RS resources belong to a sub-channel in the first resource pool.

As an embodiment, the sending timing of the sender of the first message in the first time unit is related to the first time length.

As an embodiment, the first time length is used to determine the sending timing of the sender of the first message in the first time unit.

As an embodiment, the sending timing of the first RS is related to the first time length.

As an embodiment, the first time length is used to determine the sending timing of the first RS.

As an embodiment, the first time length is a timing advance (Timing Advance).

As an embodiment, the first time length is one of multiple time lengths.

As an embodiment, the first time length is related to the subcarrier spacing of the first RS resource in the frequency domain.

As an embodiment, the subcarrier spacing of the first RS resource in the frequency domain is used to determine the first time length from the multiple time lengths.

As an embodiment, the index of the first time length is used to indicate the position of the first time length among the multiple time lengths.

As an embodiment, the index of the first time length is used to indicate the first time length from among the multiple time lengths.

As an embodiment, the index of the first time length is one of T consecutive non-negative integers starting from 0, and T is a positive integer greater than 1.

As an embodiment, the index of the first time length is one of 3847 consecutive non-negative integers from 0 to 3846.

As an embodiment, the index of the first time length is one of {0, 1, 2, . . . 3846}.

As an embodiment, the index of the first time length is one of 64 consecutive non-negative integers from 0 to 63.

As an embodiment, the index of the first time length is one of {0, 1, 2, . . . 63}.

As an embodiment, the first time length is related to the index of the first time length and the subcarrier spacing of the first RS resource in the frequency domain.

As an embodiment, the first time length is equal to the quotient of the product of the index of the first time length and 16 and 64 respectively divided by 2^{μ}, where μ is a non-negative integer and μ is related to the subcarrier spacing of the first RS resource in the frequency domain.

As an embodiment, the resolution of the first time length is T_{C}, where T_{C} is 1/(480000×4096) seconds.

As an embodiment, the resolution of the first time length is a positive integer multiple of T_{C}, and T_{C} is 1/(480000×4096) seconds.

As an embodiment, the first time length is equal to (TA×16×64/2^{μ})×T_{C}, μ is a non-negative integer, TA is the index of the first time length, and T_{C} is 1/(480000×4096) seconds.

As an embodiment, the u is related to the subcarrier spacing of the at least first RS resource in the frequency domain.

As an embodiment, μ is one of {0, 1, 2, 3, 4, 5, 6}.

As an embodiment, the first time length is related to a second time length, and the second time length is a time length before the first message is received.

As an embodiment, the second time length is one of the multiple time lengths.

As an embodiment, the first time length is related to the second time length, the index of the first time length and the subcarrier spacing of the first RS resource in the frequency domain.

As an embodiment, the second time length is a timing advance before the first message is received.

As an embodiment, the second time length is a timing advance of the first node before the first message is received.

As an embodiment, the first time length is equal to the second time length+((TA−31)×16×64/2^{μ})×T_{C}, μ is a non-negative integer, TA is the index of the first time length, and TC is 1/(480000×4096) seconds.

As an embodiment, the subcarrier spacing of the first RS resource in the frequency domain is 24×15 kHz.

As an embodiment, the unit of the first time length is s (seconds).

As an embodiment, the unit of the first time length is ms (milliseconds).

As an embodiment, the first time length is no greater than 2 ms.

As an embodiment, the first time length is no more than 1 ms.

As an embodiment, the first message is used to indicate the first time length.

As an embodiment, the first message indicates the index of the first time length among the multiple time lengths.

As an embodiment, the first message indicates the index of the first time length.

As an embodiment, the first message includes a timing advance command (Timing Advance Command).

As an embodiment, the first message indicates the at least first RS resource.

As an embodiment, the first message is used to configure the at least first RS.

As an embodiment, the first message is used to configure the first RS.

As an embodiment, the first message is used to configure the first RS resource.

As an embodiment, the first message includes configuration information of at least the first RS.

As an embodiment, the first message includes configuration information of the first RS.

As an embodiment, the first message is used to configure the sending of the first location information.

As an embodiment, the first message is used to configure reporting of the first location information.

As an embodiment, the first message is used to trigger the sending of the first location information.

As an embodiment, the first message is used to trigger the reporting of the first location information.

As an embodiment, the first message includes all or part of a higher layer signaling.

As an embodiment, the first message includes one or more RRC IEs (Radio Resource Control Information Elements).

As an embodiment, the first message includes one or more MAC CEs (Multimedia Access Control Control Elements).

As an embodiment, the first message includes one or more PHY layer (Physical Layer) signaling.

As an embodiment, the first message includes a SCI (Sidelink Control Information).

As an embodiment, the first message includes a SL MAC CE.

As an embodiment, the first message includes an SCI and an SL MAC CE.

As an embodiment, the first message includes a first bit block, and the first bit block includes multiple bits.

As an embodiment, the first message includes an SCI and the first bit block.

As an embodiment, the first bit block is used to generate the SL MAC CE.

As an embodiment, the first bit block includes a CW (Codeword).

As an embodiment, the first bit block includes a CB (Code Block).

As an embodiment, the first bit block includes a TB (Transport Block).

As an embodiment, the first message is carried on PSCCH (Physical Sidelink Control Channel).

As an embodiment, the first message is carried on PSSCH (Physical Sidelink Shared Channel).

As an embodiment, the first message is carried on PSCCH and PSSCH.

As an embodiment, the time-frequency resources occupied by the first message belong to a resource pool (Resource Pool).

As an embodiment, the time domain resources occupied by the first message belong to an SL (Sidelink) resource pool.

As an embodiment, the first measurement includes receiving timing measurement (Receiving Timing/Reception Timing/Received Timing/Rx Timing).

As an embodiment, the first measurement includes Rx-Tx time difference measurement.

As an embodiment, the first measurement includes UE Rx-Tx time difference measurement.

As an embodiment, the first measurement includes a Sidelink Rx-Tx time difference measurement.

As an embodiment, the first measurement includes a positioning measurement.

As an embodiment, the first measurement includes a location related measurement.

As an embodiment, the first measurement includes a sidelink positioning measurement.

As an embodiment, the first measurement is used to obtain the first position information.

As an embodiment, the first measurement is used to obtain the time difference between sending and receiving.

As an embodiment, the first measurement is used to obtain a first transmitting and receiving time difference.

As an embodiment, the first measurement is used to obtain a first equivalent transmit-receive time difference.

As an embodiment, the first measurement is used to obtain the receive timing (Rx Timing) of the first time unit.

As an embodiment, a result of performing the first measurement is the reception timing of the first time unit.

As an embodiment, a result of performing the first measurement is the reception timing of the first time unit.

As an embodiment, a result of performing the first measurement is used to generate the first transmit-receive time difference.

As an embodiment, a result of performing the first measurement is used to generate the first equivalent transmit-receive time difference.

As an embodiment, a result of performing the first measurement is used to generate the first position information.

As an embodiment, the result of performing the first measurement is reported to a LMF (Location Management Function).

As an embodiment, the result of performing the first measurement is transmitted to the second node in the present application.

As an embodiment, the multi-carrier symbol is an OFDM (Orthogonal Frequency Division Multiplexing) symbol.

As an embodiment, the multi-carrier symbol is a SC-FDMA (Single-Carrier Frequency Division Multiple Access) symbol.

As an embodiment, the multi-carrier symbol is a DFT-S-OFDM (Discrete Fourier Transform Spread Orthogonal Frequency Division Multiplexing) symbol.

As an embodiment, the multi-carrier symbol is an IFDMA (Interleaved Frequency Division Multiple Access) symbol.

As an embodiment, the first time unit includes the time domain resources of the first RS resources.

As an embodiment, the first time unit includes a time domain resource of a first type of RS resource among the at least first RS resources.

As an embodiment, the first time unit includes the time domain resource of the last first-category RS resource in the time domain among the at least first RS resource.

As an embodiment, the first RS resource belongs to the first time unit in the time domain.

As an embodiment, one of the first type RS resources among the at least first RS resources belongs to the first time unit in the time domain.

As an embodiment, the receiving timing of the first time unit is the timing of the first time unit of the first path detected by the first node in the time domain.

As an embodiment, the reception timing of the first time unit is the start of a first time unit of a first arrival path from the second node.

As an embodiment, the reception timing of the first time unit is the start of a first time unit of a first arrival path from the second node detected by the first node.

As an embodiment, the first time unit is a subframe.

As an embodiment, the first time unit is a sidelink subframe (Sidelink Subframe).

As an embodiment, the first time unit is an uplink subframe (Uplink Subframe).

As an embodiment, the first time unit is a subframe, and the subframe includes an uplink symbol (Uplink Symbol).

As an embodiment, the uplink symbol is the multi-carrier symbol.

As an embodiment, the first time unit is a subframe, and the subframe is used for SL transmission.

As an embodiment, the first time unit is a time slot (Slot).

As an embodiment, the first time unit is a sidelink time slot (Sidelink Slot).

As an embodiment, the first time unit is an uplink time slot (Uplink Slot).

As an embodiment, the first time unit is a time slot, and the time slot includes an uplink symbol (Uplink Symbol).

As an embodiment, the first time unit is a time slot, and the time slot is used for SL transmission.

As an embodiment, the first location information is reported to a LMF (Location Management Function).

As an embodiment, the first location information is transmitted to the sender of the first message.

As an embodiment, the first location information is reported to a LMF via the sender of the first message.

As an embodiment, the first location information is transmitted to the second node in the present application.

As an embodiment, the first location information is reported to a LMF via the second node in this application.

As an embodiment, the first location information is used to determine RTT (Round Trip Time).

As an embodiment, the first location information is used by a LMF to determine the RTT.

As an embodiment, the first position information is used for positioning.

As an embodiment, the first location information is used for location related measurement.

As an embodiment, the first location information is used for sidelink positioning.

As an embodiment, the first position information is used to determine a propagation delay.

As an embodiment, the first position information is used by the LMF to determine propagation delay.

As an embodiment, the first location information is used for RTT positioning.

As an embodiment, the first location information is used for Single-sided RTT positioning.

As an embodiment, the first location information is used for Double-sided RTT positioning.

As an embodiment, the first location information is used for Multi-RTT (Multiple-Round Trip Time) positioning.

As an embodiment, the first location information (Location Information) includes a first sending and receiving time difference.

As an embodiment, the first time difference between sending and receiving is used to generate the first location information.

As an embodiment, the first location information includes location related measurements.

As an embodiment, the first location information includes a location estimate.

As an embodiment, the first location information includes positioning assistance data (Assistance Data).

As an embodiment, the first location information includes timing quality (TimingQuality).

As an embodiment, the first location information includes a receive beam index (RxBeamIndex).

As an embodiment, the first location information includes first receiving power information.

As an embodiment, the first location information is used to transfer NAS (Non-Access-Stratum) specific information.

As an embodiment, the first position information is used to transfer timing information of a clock.

As an embodiment, the first received power information includes RSRP (Reference Signal Received Power) of the first RS.

As an embodiment, the first received power information includes RSRPP (Reference Signal Received Path Power) of the first RS.

As an embodiment, the first receiving power information includes RSRP result difference (RSRP-ResultDiff).

As an embodiment, the unit of the first receiving power information is dBm (decibel milli).

As an embodiment, the unit of the first receiving power information is dB (decibel).

As an embodiment, the name of the first transmit-receive time difference includes RSTD (Reference Signal Time Difference, reference signal time power).

As an embodiment, the name of the first receiving and transmitting time difference includes RxTxTimeDiff (receiving and transmitting time difference).

As an embodiment, the name of the first receive-transmit time difference includes SL-RxTxTimeDiff (Secondary Link Receive-Transmit Time Difference).

As an embodiment, the name of the first sending and receiving time difference includes RTOA (Relative Time of Arrival, relative arrival time).

As an embodiment, the name of the first transmit-receive time difference includes SL-RTOA.

As an embodiment, the receiving timing of the first time unit and the first time length are used together to generate the first location information.

As an embodiment, the first location information is related to both the receiving timing of the first time unit and the first time length.

As an embodiment, the first location information includes the first sending and receiving time difference, and the first sending and receiving time difference is related to both the receiving timing of the first time unit and the first time length.

As an embodiment, the first location information includes the first sending and receiving time difference, and the receiving timing of the first time unit and the first time length are used together to generate the first sending and receiving time difference.

As an embodiment, the first transmitting and receiving time difference is linearly related to the receiving timing of the first time unit and the first time length.

As an embodiment, a linear sum of the receiving timing of the first time unit and the first time length is used to generate the first transmitting and receiving time difference.

As an embodiment, the difference between the receiving timing of the first time unit and the first time length is used to generate the first transmitting and receiving time difference.

### EXAMPLE 2

Embodiment 2 illustrates a schematic diagram of a network architecture according to an embodiment of the present application, as shown in FIG. 2. FIG. 2 illustrates a 5G NR (New The V2X communication architecture under the 5G NR (New Radio), LTE (Long-Term Evolution) and LTE-A (Long-Term Evolution Advanced) system architecture. The 5G NR or LTE network architecture can be referred to as 5GS (5G System)/EPS (Evolved Packet System) or some other appropriate terminology.

The V2X communication architecture of embodiment 2 includes UE (User Equipment) 201, UE 241, NG-RAN (Next Generation Radio Access Network) 202, 5GC (5G Core Network)/EPC (Evolved Packet Core) 210, HSS (Home Subscriber Server)/UDM (Unified Data Management) 220, ProSe function 250 and ProSe application server 230. The V2X communication architecture can be interconnected with other access networks, but these entities/interfaces are not shown for simplicity. As shown, the V2X communication architecture provides packet switching services, but it will be readily understood by those skilled in the art that the various concepts presented throughout this application can be extended to networks that provide circuit switching services or other cellular networks. NG-RAN includes NR Node B (gNB) 203 and other gNBs 204. gNB 203 provides user and control plane protocol terminations toward UE 201. gNB 203 can be connected to other gNBs 204 via an Xn interface (e.g., backhaul). The gNB 203 may also be referred to as a base station, a base transceiver station, a radio base station, a radio transceiver, a transceiver function, a basic service set (BSS), an extended service set (ESS), a transmit receive node (TRP), or some other suitable term. The gNB 203 provides an access point to the 5GC/EPC 210 for the UE 201. Examples of UE 201 include a cellular phone, a smart phone, a session initiation protocol (SIP) phone, a laptop computer, a personal digital assistant (PDA), a satellite radio, non-terrestrial base station communications, satellite mobile communications, a global positioning system, a multimedia device, a video device, a digital audio player (e.g., an MP3 player), a camera, a game console, a drone, an aircraft, a narrowband Internet of Things device, a machine type communication device, a land vehicle, an automobile, a wearable device, or any other similar functional device. A person skilled in the art may also refer to UE201 as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term. The gNB203 is connected to the 5GC/EPC210 via an S1/NG interface. The 5GC/EPC210 includes an MME (Mobility Management Entity)/AMF (Authentication Management Field)/SMF (Session Management Function) 211, other MME/AMF/SMF214, an S-GW (Service Gateway)/UPF (User Plane Function) 212, and a P-GW (Packet Data Network Gateway)/UPF213. MME/AMF/SMF211 is the control node that handles the signaling between UE201 and 5GC/EPC210. In general, MME/AMF/SMF211 provides bearer and connection management. All user IP (Internet Protocol) packets are transmitted through S-GW/UPF212, which itself is connected to P-GW/UPF213. P-GW provides UE IP address allocation and other functions. P-GW/UPF213 is connected to Internet services 230. Internet services 230 include operator-corresponding Internet protocol services, which may specifically include Internet, intranet, IMS (IP Multimedia Subsystem) and packet-switched streaming services. The ProSe function 250 is a logical function for network-related behaviors required for ProSe (Proximity-based Service), including DPF (Direct Provisioning Function), Direct Discovery Name Management Function, EPC-level Discovery ProSe Function, etc. The ProSe application server 230 has functions such as storing EPC ProSe user identities, mapping between application layer user identities and EPC ProSe user identities, and allocating ProSe restricted code suffix pools.

As an embodiment, the UE 201 and the UE 241 are connected via a PC5 reference point (Reference Point).

As an embodiment, the ProSe function 250 is connected to the UE 201 and the UE 241 via a PC3 reference point respectively.

As an embodiment, the ProSe function 250 is connected to the ProSe application server 230 via a PC2 reference point.

As an embodiment, the ProSe application server 230 is connected to the ProSe application of the UE 201 and the ProSe application of the UE 241 through a PC1 reference point respectively.

As an embodiment, the first node in the present application is the UE201, and the second node in the present application is the UE241.

As an embodiment, the first node in the present application is the UE241, and the second node in the present application is the UE201.

As an embodiment, the wireless link between the UE201 and the UE241 corresponds to the side link (Sidelink, SL) in this application.

As an embodiment, the wireless link from the UE201 to the NR Node B is an uplink.

As an embodiment, the wireless link from the NR Node B to UE201 is a downlink.

As an embodiment, the UE201 supports SL transmission.

As an embodiment, the UE241 supports SL transmission.

As an embodiment, the gNB203 is a macrocellular base station.

As an embodiment, the gNB203 is a micro cell base station.

As an embodiment, the gNB203 is a picoCell base station.

As an embodiment, the gNB203 is a home base station (Femtocell).

As an embodiment, the gNB203 is a base station device that supports large delay difference.

As an embodiment, the gNB203 is an RSU (Road Side Unit).

As an embodiment, the gNB203 includes a satellite device.

### EXAMPLE 3

Embodiment 3 shows a schematic diagram of an embodiment of a wireless protocol architecture of a user plane and a control plane according to the present application, as shown in FIG. 3. FIG. 3 is a schematic diagram illustrating an embodiment of a radio protocol architecture for a user plane 350 and a control plane 300. FIG. 3 shows the radio protocol architecture of the control plane 300 for a first node device (RSU in UE or V2X, vehicle-mounted device or vehicle-mounted communication module) and a second node device (gNB, RSU in UE or V2X, vehicle-mounted device or vehicle-mounted communication module), or between two UEs using three layers: Layer 1, Layer 2, and Layer 3. Layer 1 (L1 layer) is the lowest layer and implements various PHY (physical layer) signal processing functions. The L1 layer will be referred to as PHY301 herein. Layer 2 (L2 layer) 305 is above PHY301 and is responsible for the link between the first node device and the second node device and the two UEs through PHY301. The L2 layer 305 includes a MAC (Medium Access Control) sublayer 302, an RLC (Radio Link Control) sublayer 303, and a PDCP (Packet Data Convergence Protocol) sublayer 304, which terminate at the second node device. The PDCP sublayer 304 provides data encryption and integrity protection, and also provides inter-zone mobility support for the first node device to the second node device. The RLC sublayer 303 provides segmentation and reassembly of data packets, and retransmission of lost data packets through ARQ. The RLC sublayer 303 also provides duplicate data packet detection and protocol error detection. The MAC sublayer 302 provides mapping between logical and transport channels and multiplexing of logical channels. The MAC sublayer 302 is also responsible for allocating various radio resources (e.g., resource blocks) in a cell between the first node devices. The MAC sublayer 302 is also responsible for HARQ operations. The RRC (Radio Resource Control) sublayer 306 in layer 3 (L3 layer) in the control plane 300 is responsible for obtaining radio resources (i.e., radio bearers) and configuring the lower layer using RRC signaling between the second node device and the first node device. The radio protocol architecture of the user plane 350 includes layer 1 (L1 layer) and layer 2 (L2 layer). The radio protocol architecture for the first node device and the second node device in the user plane 350 is substantially the same as the corresponding layers and sublayers in the control plane 300 for the physical layer 351, the PDCP sublayer 354 in the L2 layer 355, the RLC sublayer 353 in the L2 layer 355, and the MAC sublayer 352 in the L2 layer 355, but the PDCP sublayer 354 also provides header compression for upper layer data packets to reduce wireless transmission overhead. The L2 layer 355 in the user plane 350 also includes a SDAP (Service Data Adaptation Protocol) sublayer 356, which is responsible for mapping between QoS flows and data radio bearers (DRBs) to support the diversity of services. Although not shown, the first node device may have several upper layers above the L2 layer 355, including a network layer (e.g., an IP layer) terminated at the P-GW on the network side and an application layer terminated at the other end of the connection (e.g., a remote UE, a server, etc.).

As an embodiment, the wireless protocol architecture in FIG. 3 is applicable to the first node in the present application.

As an embodiment, the wireless protocol architecture in FIG. 3 is applicable to the second node in the present application.

As an embodiment, the first message in the present application is generated in the PHY301.

As an embodiment, the first message in the present application is generated in the MAC sublayer 302.

As an embodiment, the first RS in the present application is generated in the PHY301.

As an embodiment, the first measurement in the present application is performed by the PHY 301.

the first location information in the present application is generated in the RRC sublayer 306.

### EXAMPLE 4

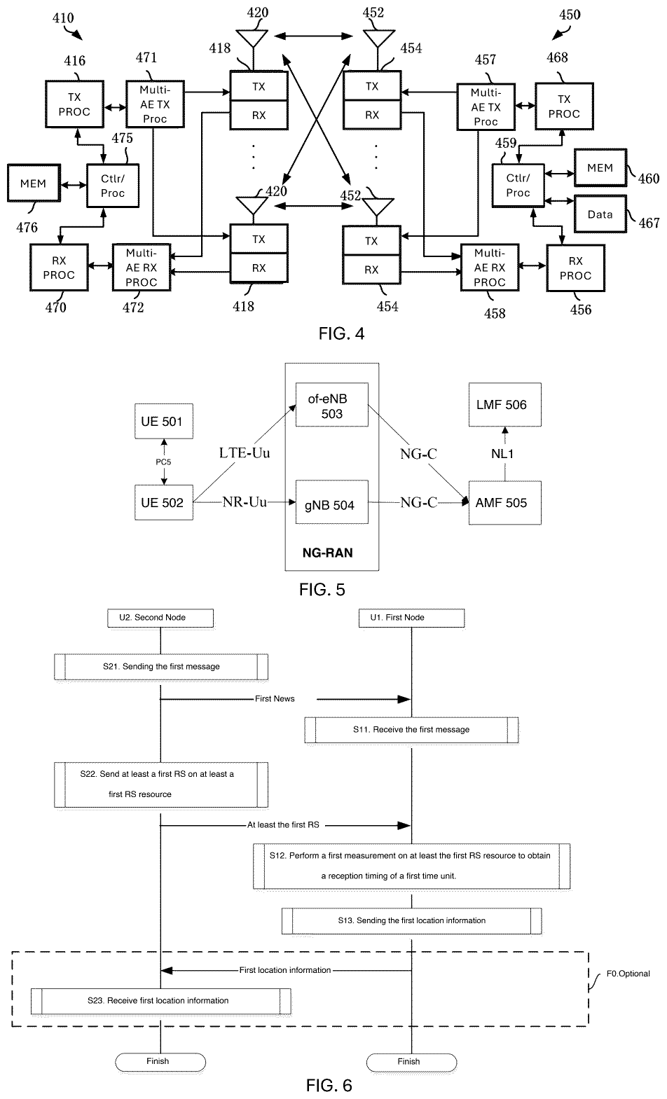

Embodiment 4 shows a schematic diagram of a first communication device and a second communication device according to the present application, as shown in FIG. 4. FIG. 4 is a block diagram of a first communication device 410 and a second communication device 450 communicating with each other in an access network.

The first communication device 410 includes a controller/processor 475, a memory 476, a receive processor 470, a transmit processor 416, a multi-antenna receive processor 472, a multi-antenna transmit processor 471, a transmitter/receiver 418 and an antenna 420.

The second communication device 450 includes a controller/processor 459, a memory 460, a data source 467, a transmit processor 468, a receive processor 456, a multi-antenna transmit processor 457, a multi-antenna receive processor 458, a transmitter/receiver 454 and an antenna 452.

In transmission from the first communication device 410 to the second communication device 450, at the first communication device 410, upper layer data packets from the core network are provided to the controller/processor 475. The controller/processor 475 implements the functionality of the L2 layer. In transmission from the first communication device 410 to the first communication device 450, the controller/processor 475 provides header compression, encryption, packet segmentation and reordering, multiplexing between logical and transport channels, and radio resource allocation to the second communication device 450 based on various priority metrics. The controller/processor 475 is also responsible for retransmission of lost packets and signaling to the second communication device 450. The transmit processor 416 and the multi-antenna transmit processor 471 implement various signal processing functions for the L1 layer (i.e., the physical layer). The transmit processor 416 implements coding and interleaving to facilitate forward error correction (FEC) at the second communication device 450, as well as mapping of signal constellations based on various modulation schemes (e.g., binary phase shift keying (BPSK), quadrature phase shift keying (QPSK), M-phase shift keying (M-PSK), M-quadrature amplitude modulation (M-QAM)). The multi-antenna transmit processor 471 performs digital spatial precoding, including codebook-based precoding and non-codebook-based precoding, and beamforming processing on the coded and modulated symbols to generate one or more spatial streams. The transmit processor 416 then maps each spatial stream to a subcarrier, multiplexes with a reference signal (e.g., a pilot) in the time domain and/or frequency domain, and then uses an inverse fast Fourier transform (IFFT) to generate a physical channel carrying a time-domain multi-carrier symbol stream. The multi-antenna transmit processor 471 then performs a transmit analog precoding/beamforming operation on the time-domain multi-carrier symbol stream. Each transmitter 418 converts the baseband multi-carrier symbol stream provided by the multi-antenna transmit processor 471 into a radio frequency stream, and then provides it to a different antenna 420.

In the transmission from the first communication device 410 to the second communication device 450, at the second communication device 450, each receiver 454 receives a signal through its corresponding antenna 452. Each receiver 454 recovers the information modulated onto the RF carrier and converts the RF stream into a baseband multi-carrier symbol stream and provides it to the receiving processor 456. The receiving processor 456 and the multi-antenna receiving processor 458 implement various signal processing functions of the L1 layer. The multi-antenna receiving processor 458 performs a receiving analog precoding/beamforming operation on the baseband multi-carrier symbol stream from the receiver 454. The receiving processor 456 uses a fast Fourier transform (FFT) to convert the baseband multi-carrier symbol stream after the receiving analog precoding/beamforming operation from the time domain to the frequency domain. In the frequency domain, the physical layer data signal and the reference signal are demultiplexed by the receiving processor 456, wherein the reference signal will be used for channel estimation, and the data signal is recovered after multi-antenna detection in the multi-antenna receiving processor 458 to any spatial stream destined for the second communication device 450. The symbols on each spatial stream are demodulated and recovered in the receive processor 456, and soft decisions are generated. The receive processor 456 then decodes and deinterleaves the soft decisions to recover the upper layer data and control signals transmitted by the first communication device 410 on the physical channel. The upper layer data and control signals are then provided to the controller/processor 459. The controller/processor 459 implements the functions of the L2 layer. The controller/processor 459 may be associated with a memory 460 that stores program codes and data. The memory 460 may be referred to as a computer-readable medium. In the transmission from the first communication device 410 to the second communication device 450, the controller/processor 459 provides multiplexing between transport and logical channels, packet reassembly, decryption, header decompression, control signal processing to recover the upper layer data packets from the core network. The upper layer data packets are then provided to all protocol layers above the L2 layer. Various control signals may also be provided to the L3 for L3 processing.

In the transmission from the second communication device 450 to the first communication device 410, at the second communication device 450, a data source 467 is used to provide upper layer data packets to the controller/processor 459. The data source 467 represents all protocol layers above the L2 layer. Similar to the transmission function at the first communication device 410 described in the transmission from the first communication device 410 to the second communication device 450, the controller/processor 459 implements header compression, encryption, packet segmentation and reordering, and multiplexing between logical and transport channels based on radio resource allocation, and implements L2 layer functions for user plane and control plane. The controller/processor 459 is also responsible for the retransmission of lost packets and signaling to the first communication device 410. The transmit processor 468 performs modulation mapping and channel coding processing, and the multi-antenna transmit processor 457 performs digital multi-antenna spatial precoding, including codebook-based precoding and non-codebook-based precoding, and beamforming processing. Then, the transmit processor 468 modulates the generated spatial stream into a multi-carrier/single-carrier symbol stream, which is then provided to different antennas 452 via the transmitter 454 after analog precoding/beamforming operations in the multi-antenna transmit processor 457. Each transmitter 454 first converts the baseband symbol stream provided by the multi-antenna transmit processor 457 into a radio frequency symbol stream, and then provides it to the antenna 452.

In the transmission from the second communication device 450 to the first communication device 410, the functions at the first communication device 410 are similar to the reception functions at the second communication device 450 described in the transmission from the first communication device 410 to the second communication device 450. Each receiver 418 receives a radio frequency signal through its corresponding antenna 420, converts the received radio frequency signal into a baseband signal, and provides the baseband signal to the multi-antenna reception processor 472 and the reception processor 470. The reception processor 470 and the multi-antenna reception processor 472 jointly implement the functions of the L1 layer. The controller/processor 475 implements the L2 layer functions. The controller/processor 475 can be associated with a memory 476 that stores program codes and data. The memory 476 can be referred to as a computer-readable medium. In the transmission from the second communication device 450 to the first communication device 410, the controller/processor 475 provides demultiplexing between transport and logical channels, packet reassembly, decryption, header decompression, control signal processing to recover the upper layer data packets from the UE 450. Upper layer packets from the controller/processor 475 may be provided to the core network.

As an embodiment, the second communication device 450 includes: at least one processor and at least one memory, the at least one memory includes computer program code; the at least one memory and the computer program code are configured to be used together with the at least one processor. The second communication device 450 device at least: receives a first message; performs a first measurement in at least a first RS resource to obtain a reception timing of a first time unit; sends first location information; the first message indicates a first time length, and the reception timing of the first time unit and the first time length are used together to generate the first location information.

As an embodiment, the second communication device 450 includes: a memory storing a computer-readable instruction program, wherein the computer-readable instruction program generates actions when executed by at least one processor, and the actions include: receiving a first message; performing a first measurement in at least a first RS resource to obtain a receiving timing of a first time unit; sending first location information; the first message indicates a first time length, and the receiving timing of the first time unit and the first time length are jointly used to generate the first location information.

As an embodiment, the first communication device 410 includes: at least one processor and at least one memory, the at least one memory includes computer program code; the at least one memory and the computer program code are configured to be used together with the at least one processor. The first communication device 410 device at least: sends a first message; sends at least a first RS on at least a first RS resource; receives first location information; wherein the first message indicates a first time length, the first location information includes a first transceiver time difference, and the first transceiver time difference is related to the first time length.

As an embodiment, the first communication device 410 includes: a memory storing a computer-readable instruction program, wherein the computer-readable instruction program generates actions when executed by at least one processor, and the actions include: sending a first message; sending at least a first RS on at least a first RS resource; receiving first location information; wherein the first message indicates a first time length, the first location information includes a first sending and receiving time difference, and the first sending and receiving time difference is related to the first time length.

As an embodiment, the second communication device 450 corresponds to the first node in this application.

As an embodiment, the first communication device 410 corresponds to the second node in this application.

As an embodiment, the second communication device 450 is a UE.

As an embodiment, the first communication device 410 is a UE.

As an embodiment, at least one of {the antenna 452, the receiver 454, the multi-antenna receiving processor 458, the receiving processor 456, the controller/processor 459, and the memory 460} is used to receive the first message in the present application.

As an embodiment, at least one of {the antenna 452, the receiver 454, the multi-antenna reception processor 458, the reception processor 456, the controller/processor 459, and the memory 460} is used in the present application to perform a first measurement on at least a first RS resource to obtain the reception timing of a first time unit.

As an embodiment, at least one of {the antenna 452, the transmitter 454, the multi-antenna transmit processor 457, the transmit processor 468, the controller/processor 459, the memory 460, the data source 467} is used to send the first location information in the present application.

As an embodiment, at least one of {the antenna 420, the transmitter 418, the multi-antenna transmit processor 471, the transmit processor 416, the controller/processor 475, and the memory 476} is used to send the first message in the present application.

As an embodiment, at least one of {the antenna 420, the transmitter 418, the multi-antenna transmit processor 471, the transmit processor 416, the controller/processor 475, and the memory 476} is used to send at least a first RS on at least a first RS resource in the present application.

As an embodiment, at least one of {the antenna 420, the receiver 418, the multi-antenna receiving processor 472, the receiving processor 470, the controller/processor 475, and the memory 476} is used to receive the first location information in the present application.

### EXAMPLE 5

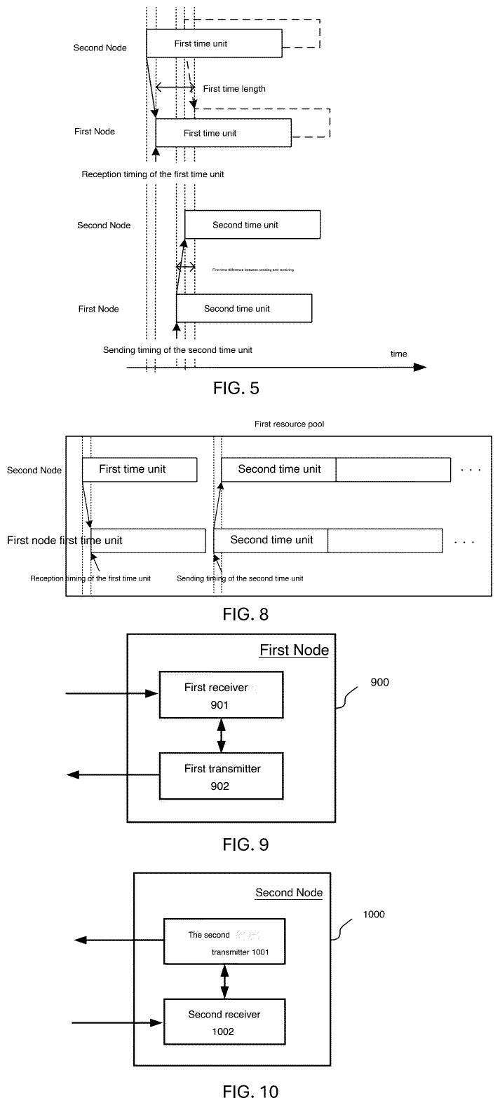

Embodiment 5 illustrates a structural diagram of UE positioning according to an embodiment of the present application, as shown in FIG. 5.

UE501 communicates with UE502 via PC5 interface; UE502 communicates with ng-eNB503 or gNB504 via LTE (Long Term Evolution)-Uu interface or NR (New Radio)-Uu new wireless interface; ng-eNB503 and gNB504 are sometimes referred to as base stations, and ng-eNB503 and gNB504 are also referred to as NG (Next Generation)-RAN (Radio Access Network). ng-eNB503 and gNB504 are connected to AMF (Authentication Management Field) 505 via NG (Next Generation)-C (Control plane) respectively; AMF505 is connected to LMF (Location Management Function) 506 via NL1 interface.

The AMF505 receives a location service request associated with a specific UE from another entity, such as a GMLC (Gateway Mobile Location Centre) or a UE, or the AMF505 decides to start the location service associated with the specific UE; then the AMF505 sends the location service request to an LMF, such as the LMF506; then the LMF processes the location service request, including sending auxiliary data to the specific UE to assist UE-based or UE-assisted positioning, and including receiving location information reported by the UE; then the LMF returns the result of the location service to the AMF505; if the location service is requested by another entity, the AMF505 returns the result of the location service to that entity.

As an embodiment, the network device of the present application includes LMF.

As an embodiment, the network equipment of the present application includes NG-RAN and LMF.

As an embodiment, the network equipment of the present application includes NG-RAN, AMF and LMF.

### EXAMPLE 6

Embodiment 6 illustrates a wireless signal transmission flow chart according to an embodiment of the present application, as shown in FIG. 6. In FIG. 6, the first node U1 and the second node U2 communicate via an air interface. In FIG. 5, the steps in the dotted box F0 are optional.

For the first node U1, a first message is received in step S11; a first measurement is performed on at least a first RS resource to obtain a reception timing of a first time unit in step S12; and first location information is sent in step S13.

For the second node U2, a first message is sent in step S21; at least a first RS is sent on at least a first RS resource in step S22; and first location information is received in step S23.

In embodiment 6, the first message indicates a first time length, the receiving timing of the first time unit and the first time length are used together to generate the first location information; the first location information includes a first receiving and sending time difference, the first receiving and sending time difference is the linear sum of the receiving timing of the first time unit, the first time length and the sending timing of the second time unit; the at least first RS resource includes multiple first-class RS resources, the first RS resource is one of the multiple first-class RS resources, and at least one of the multiple first-class RS resources is used to carry SL PRS; the first time unit includes a time domain resource of the first RS resource, or the first time unit includes a time domain resource of one of the multiple first-class RS resources, or the first time unit is associated with the at least first RS resource; the first resource pool includes multiple first-class time units in the time domain, the first time unit is a first-class time unit in the first resource pool, and the second time unit is a first-class time unit in the multiple first-class time units included in the first resource pool that is closest to the first time unit in the time domain; the second time unit is used by the first node U1 to send a wireless signal; the first message is an SCI, or the first message is an SL MAC CE; The time-frequency resources occupied by the first message belong to a second resource pool, and the second resource pool is different from the first resource pool.

As an embodiment, the above steps are helpful for the second node U2 to flexibly adjust the sending timing.

As an embodiment, the above steps are helpful to save the signaling overhead of the first location information.

As an embodiment, the first node U1 and the second node U2 communicate with each other through a PC5 interface.

As an embodiment, the steps in block F0 in FIG. 5 exist.

As an embodiment, the step in block F0 in FIG. 5 does not exist.

As an embodiment, the first node U1 sends the first location information to the second node U2.

As an embodiment, the first node U1 sends the first location information to the second node U2, and the second node U2 reports the first location information to the LMF.

As an embodiment, the first node U1 reports the first location information to LMF.

As an embodiment, when the first node U1 sends the first location information to the second node U2, the steps in box F0 in FIG. 5 exist.

As an embodiment, when the first node U1 reports the first location information to the LMF, the step in box F0 in FIG. 5 does not exist.

### EXAMPLE 7

Embodiment 7 illustrates a schematic diagram of the relationship between the first receiving and sending time difference and the receiving timing of the first time unit, the first time length and the sending timing of the second time unit according to an embodiment of the present application, as shown in FIG. 7.

In Embodiment 7, the first location information includes a first time difference between sending and receiving, and the first time difference between sending and receiving is linearly correlated with the first time length, the receiving timing of the first time unit, and the sending timing of the second time unit.

As an embodiment, the first receiving-transmitting time difference is an equivalent receiving-transmitting time difference (Rx-Tx Time Difference).

As an embodiment, the first time length, the receiving timing of the first time unit and the sending timing of the second time unit are used together to determine the first sending and receiving time difference.

As an embodiment, the first time length, the receiving timing of the first time unit and the sending timing of the second time unit are used together to generate the first sending and receiving time difference.

As an embodiment, the first receiving and sending time difference is the linear sum of the first time length, the receiving timing of the first time unit and the sending timing of the second time unit.

As an embodiment, the first receiving and sending time difference is the difference between the receiving timing of the first time unit minus the first time length minus the sending timing of the second time unit.

As an embodiment, the first receiving and sending time difference=(the receiving timing of the first time unit-the first time length−the sending timing of the second time unit).

As an embodiment, the first receiving and sending time difference is the linear sum of the difference between the receiving timing of the first time unit and the sending timing of the second time unit and the first time length.

As an embodiment, the first receiving and sending time difference is the linear sum of the difference between the receiving timing of the first time unit and the first time length and the sending timing of the second time unit.

As an embodiment, the first receiving and sending time difference is the difference between the receiving timing of the first time unit and the sending timing of the second time unit and the linear subtraction of the first time length.

As an embodiment, the first receiving and sending time difference is the difference between the receiving timing of the first time unit and the first time length and the linear subtraction of the sending timing of the second time unit.

As an embodiment, the first receiving/transmitting time difference is the difference between the first receiving/transmitting time difference and the first time length, and the first receiving/transmitting time difference is the difference between the receiving timing of the first time unit and the sending timing of the second time unit.

As an embodiment, the first receiving and sending time difference is the difference between the equivalent receiving timing of the first time unit and the sending timing of the second time unit, and the equivalent receiving timing of the first time unit is the difference between the receiving timing of the first time unit and the first time length.

As an embodiment, the resolution of×the first receiving and transmitting time difference is Ts, where Ts is 1/(15000 2048) seconds.

As an embodiment, the resolution of the first receiving and sending time difference is a positive integer multiple of Ts, where Ts is 1/(15000×2048) seconds.

As an embodiment, the first sending and receiving time difference is no more than 1 ms.

As an embodiment, the first receiving and transmitting time difference is not greater than one CP (cyclic prefix).

### EXAMPLE 8

Embodiment 8 illustrates a schematic diagram of the relationship between the first time unit and the second time unit according to an embodiment of the present application, as shown in FIG. 8.

In Embodiment 8, the first resource pool includes a plurality of first-type time units in the time domain, the second time unit is closest to the first time unit in the time domain, and the second time unit is used by the first node to send wireless signals.

As an embodiment, the second time unit is adjacent to the first time unit in the time domain.

As an embodiment, the second time unit is closest to the first time unit in the time domain.

As an embodiment, the first time unit and the second time unit are respectively two first-class time units among multiple first-class time units, and the second time unit is a first-class time unit among the multiple first-class time units that is closest to the first time unit in the time domain.

As an embodiment, the multiple first-type time units are used for SL transmission.

As an embodiment, any first-type time unit among the multiple first-type time units includes at least one uplink symbol.

As an embodiment, the second time unit is used by the first node to send a wireless signal.

As an embodiment, the first time unit is used by the first node to receive wireless signals, and the second time unit is used by the first node to send wireless signals.

As an embodiment, the first time unit is used by the first node for SL reception, and the second time unit is used by the first node for SL transmission.

As an embodiment, the second time unit is closest to the first time unit in the time domain, and the second time unit is used by the first node to send wireless signals.

As an embodiment, the sending timing of the second time unit is the start of the second time unit.

As an embodiment, the sending timing of the second time unit is the start of the first node sending the SL signal after receiving the first time unit.

As an embodiment, the sending timing of the second time unit is the sending time closest to the receiving timing of the first time unit.

As an embodiment, the second time unit is a subframe.

As an embodiment, the second time unit is a secondary link subframe.

As an embodiment, the second time unit is an uplink subframe.

As an embodiment, the second time unit is a subframe, and the subframe includes uplink symbols.

As an embodiment, the second time unit is a subframe, and the subframe is used for SL transmission.

As an embodiment, the second time unit is a time slot.

As an embodiment, the second time unit is a secondary link time slot.

As an embodiment, the second time unit is an uplink time slot.

As an embodiment, the second time unit is a time slot, and the time slot includes uplink symbols.

As an embodiment, the second time unit is a time slot, and the time slot is used for SL transmission.

As an embodiment, the first resource pool includes a secondary link resource pool.

As an embodiment, the first resource pool is used for SL transmission.

As an embodiment, the first resource pool is used to transmit SL PRS.

As an embodiment, the first resource pool includes the multiple first-type time units in the time domain.

As an embodiment, the time domain resources occupied by the first resource pool in the time domain include the multiple first-type time units.

As an embodiment, at least two adjacent first-type time units among the multiple first-type time units included in the first resource pool in the time domain are discontinuous in time.

As an embodiment, the multiple first-type time units included in the first resource pool are multiple time slots respectively.

As an embodiment, the multiple first-type time units included in the first resource pool are multiple subframes respectively.

As an embodiment, the first time unit is a first-type time unit of the time domain resources including the first RS resource among the multiple first-type time units included in the first resource pool in the time domain.

As an embodiment, the first time unit is one of the multiple first-type time units included in the first resource pool in the time domain, and the first time unit includes the time domain resources of the first RS resources.

As an embodiment, the first time unit is one of the multiple first-type time units included in the first resource pool in the time domain, and the first time unit includes a time domain resource of a first-type RS resource among the at least first RS resources.

As an embodiment, the first time unit is one of the multiple first-class time units included in the first resource pool in the time domain, and the second time unit is a first-class time unit among the multiple first-class time units included in the first resource pool that is closest to the first time unit in the time domain.

### EXAMPLE 9

Embodiment 9 illustrates a structural block diagram of a processing device used in a first node, as shown in FIG. 9. In embodiment 9, the first node device processing device 900 is mainly composed of a first receiver 901 and a first transmitter 902.

As an embodiment, the first receiver 901 includes at least one of the antenna 452, transmitter/receiver 454, multi-antenna reception processor 458, reception processor 456, controller/processor 459, and memory 460 in FIG. 4 of the present application.

As an embodiment, the first transmitter 902 includes at least one of the antenna 452, transmitter/receiver 454, multi-antenna transmitter processor 457, transmit processor 468, controller/processor 459, memory 460 and data source 467 in FIG. 4 of the present application.

In embodiment 9, the first receiver 901 receives a first message; the first receiver 901 performs a first measurement in at least a first RS resource to obtain a receiving timing of a first time unit; the first transmitter 902 sends first location information; the first message indicates a first time length, and the receiving timing of the first time unit and the first time length are jointly used to generate the first location information.

As an embodiment, the first location information includes a first receiving and sending time difference, and the first receiving and sending time difference is a linear sum of the receiving timing of the first time unit, the first time length and the sending timing of the second time unit.

As an embodiment, the at least first RS resource includes multiple first-class RS resources, the first RS resource is one of the multiple first-class RS resources, and at least one first-class RS resource of the multiple first-class RS resources is used to carry SL PRS (Sidelink Positioning Reference Signal).

As an embodiment, the first time unit includes the time domain resource of the first RS resource, or the first time unit includes the time domain resource of one first-category RS resource among the multiple first-category RS resources.

As an embodiment, the second time unit is closest to the first time unit in the time domain.

As an embodiment, the first resource pool includes multiple first-type time units in the time domain, and the first time unit is a first-type time unit of the time domain resources including the first RS resource among the multiple first-type time units included in the first resource pool in the time domain.

As an embodiment, the first resource pool includes multiple first-class time units in the time domain, the first time unit is a first-class time unit in the first resource pool, and the second time unit is a first-class time unit among the multiple first-class time units included in the first resource pool that is closest to the first time unit in the time domain.

As an embodiment, the second time unit is used by the first node to send a wireless signal.

As an embodiment, the first message is an SCI, or the first message is an SL MAC CE.

As an embodiment, the first resource pool includes at least the first RS resource, the time-frequency resources occupied by the first message belong to the second resource pool, and the second resource pool is different from the first resource pool.

As an embodiment, the first node 900 is a user equipment.

As an embodiment, the first node 900 is a relay node.

As an embodiment, the first node 900 is a roadside device.

### EXAMPLE 10

Embodiment 10 illustrates a structural block diagram of a processing device used in a second node, as shown in FIG. 10. In embodiment 10, the second node device processing device 1000 is mainly composed of a second transmitter 1001 and a second receiver 1002.

As an embodiment, the second transmitter 1001 includes at least one of the antenna 420, the transmitter/receiver 418, the multi-antenna transmission processor 471, the transmission processor 416, the controller/processor 475, and the memory 476 in FIG. 4 of the present application.

As an embodiment, the second receiver 1002 includes at least one of the antenna 420, the transmitter/receiver 418, the multi-antenna receiving processor 472, the receiving processor 470, the controller/processor 475, and the memory 476 in FIG. 4 of the present application.

In embodiment 10, the second transmitter 1001 sends a first message; the second transmitter 1001 sends at least a first RS on at least a first RS resource; the second receiver 1002 receives first position information; the first message indicates a first time length, the first position information includes a first sending and receiving time difference, and the first sending and receiving time difference is related to the first time length.

As an embodiment, the first location information includes a first equivalent receiving and sending time difference, which is a linear sum of the receiving timing of the first time unit, the first time length and the sending timing of the second time unit.

As an embodiment, the at least first RS resource includes multiple first-category RS resources, the first RS resource is one of the multiple first-category RS resources, the at least first RS includes multiple first-category RSs, and at least one of the multiple first-category RSs is a SL PRS.

As an embodiment, the first time unit includes the time domain resource of the first RS resource, or the first time unit includes the time domain resource of one first-category RS resource among the multiple first-category RS resources.

As an embodiment, the second time unit is closest to the first time unit in the time domain.

As an embodiment, the first resource pool includes multiple first-type time units in the time domain, and the first time unit is a first-type time unit of the time domain resources including the first RS resource among the multiple first-type time units included in the first resource pool in the time domain.

As an embodiment, the first resource pool includes multiple first-class time units in the time domain, the first time unit is a first-class time unit in the first resource pool, and the second time unit is a first-class time unit among the multiple first-class time units included in the first resource pool that is closest to the first time unit in the time domain.

As an embodiment, the second time unit is used by the second node to receive a wireless signal from the first node.

As an embodiment, the first message is an SCI, or the first message is an SL MAC CE.

As an embodiment, the first resource pool includes at least the first RS resource, the time-frequency resources occupied by the first message belong to the second resource pool, and the second resource pool is different from the first resource pool.

As an embodiment, the second node 1000 is a user equipment.

As an embodiment, the second node 1000 is a relay node.

As an embodiment, the second node 1000 is a roadside device.

A person of ordinary skill in the art can understand that all or part of the steps in the above method can be completed by instructing the relevant hardware through a program, and the program can be stored in a computer-readable storage medium, such as a read-only memory, a hard disk or an optical disk. Optionally, all or part of the steps in the above embodiment can also be implemented using one or more integrated circuits. Accordingly, each module unit in the above embodiment can be implemented in the form of hardware or in the form of a software function module, and the present application is not limited to any specific form of software and hardware combination. The first node device in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The second node device in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The user equipment or UE or terminal in the present application includes but is not limited to mobile phones, tablet computers, notebooks, Internet cards, low-power devices, eMTC devices, NB-IOT devices, vehicle-mounted communication devices, aircraft, airplanes, drones, remote-controlled aircraft and other wireless communication devices. The base station equipment or base station or network side equipment in this application includes but is not limited to macrocellular base stations, microcellular base stations, home base stations, relay base stations, eNB, gNB, transmission receiving nodes TRP, GNSS, relay satellites, satellite base stations, aerial base stations and other wireless communication equipment.

The above is only a preferred embodiment of the present application and is not intended to limit the protection scope of the present application. Any modification, equivalent replacement, improvement, etc. made within the spirit and principle of the present application shall be included in the protection scope of the present application.

1. A first node for wireless communication, comprising:
a first receiver, configured to receive a first message and to perform a first measurement in at least a first Reference Signal (RS) resource to obtain a receiving timing of the first time unit; and
a first transmitter, configured to send first location information;
wherein the first message indicates a first time length, and the receiving timing of the first time unit and the first time length are jointly used to generate the first location information.

2. The first node according to claim 1, wherein the first position information comprises a first transceiving time difference, and the first transceiving time difference is a sum of linear addition of the receiving timing of the first time unit, the first time length and the sending timing of the second time unit.

3. The first node according to claim 2, wherein the at least first RS resource comprises a plurality of first-type RS resources, the first RS resource is one of the plurality of first-type RS resources, and at least one of the plurality of first-type RS resources is used to carry a Sidelink Positioning Reference Signal (SL PRS).

4. The first node according to claim 3, wherein the first time unit comprises a time domain resource of the first RS resource, or the first time unit comprises a time domain resource of one of the plurality of first type RS resources.

5. The first node according to claim 4, wherein the second time unit is closest to the first time unit in a time domain.

6. The first node according to claim 3, wherein the first resource pool includes a plurality of first-type time units in a time domain, and the first time unit is a first-type time unit of a time-domain resource including the first RS resource in the plurality of first-type time units included in the time domain by the first resource pool.

7. The first node according to any claim 3, wherein the first resource pool includes a plurality of first-type time units in a time domain, the first time unit is a first-type time unit in the first resource pool, and the second time unit is a first-type time unit closest to the first time unit in time domain in the plurality of first-type time units included in the first resource pool.

8. The first node according to claim 7, wherein the second time unit is used by the first node to send a wireless signal.

9. The first node according to claim 8, wherein the first message is Sidelink Control Information (SCI), or the first message is Sidelink Multimedia Access Control Control Elements (SL MAC CE).

10. The first node according to claim 9, wherein the first resource pool comprises the at least first RS resource, a time-frequency resource occupied by the first message belongs to a second resource pool, and the second resource pool is different from the first resource pool.

11. A second node for wireless communication, comprising:
a second transmitter, configured to send a first message; transmit at least a first Reference Signal (RS) in at least a first RS resource;
a second receiver, configured to receive first location information;
wherein the first message indicates a first time length, the first position information includes a first transceiving time difference, and the first transceiving time difference is related to the first time length.

12. The second node according to claim 11, wherein
the first position information includes a first equivalent transceiving time difference, and the first equivalent transceiving time difference is a sum of linear addition of the receiving timing of the first time unit, the first time length, and the sending timing of the second time unit.

13. The second node according to claim 12, wherein
the at least first RS resource includes a plurality of first-type RS resources, the first RS resource is one of the plurality of first-type RS resources, the at least first RS includes a plurality of first-type RSs, and at least one of the plurality of first-type RSs is an SL PRS.

14. The second node according to claim 13, characterized in that,
the first time unit includes a time domain resource of the first RS resource, or the first time unit includes a time domain resource of one of the plurality of first type RS resources.

15. The second node according to claim 14, characterized in that,
the second time unit is closest to the first time unit in a time domain.

16. The second node according to claim 13, characterized in that,
the first resource pool includes a plurality of first-type time units in a time domain, and the first time unit is a first-type time unit of a time domain resource including the first RS resource in the plurality of first-type time units included in the time domain by the first resource pool.

17. The second node according to claim to 13, characterized in that,
the first resource pool includes a plurality of first-type time units in a time domain, the first time unit is a first-type time unit in the first resource pool, and the second time unit is a first-type time unit closest to the first time unit in time domain in the plurality of first-type time units included in the first resource pool.

18. The second node according to claim 17, characterized in that,
the second time unit is used by the second node to receive a wireless signal from the first node.

19. The second node according to claim 18, characterized in that,
the first message is Sidelink Control Information (SCI), or the first message is Sidelink Multimedia Access Control Control Elements (SL MAC CE).

20. The second node according to claim 19, characterized in that,
the first resource pool includes the at least first RS resource, a time-frequency resource occupied by the first message belongs to a second resource pool, and the second resource pool is different from the first resource pool.

21-40. (canceled)
